(19) United States
(12) Patent Application Publication
(10) Pub. No.: US 2024/0112496 A1
(43) Pub. Date: Apr. 4, 2024

(54) IMAGE PROCESSING APPARATUS, AUTHENTICATION SYSTEM, METHOD, AND NON-TRANSITORY COMPUTER-READABLE STORAGE MEDIUM

(71) Applicant: CANON KABUSHIKI KAISHA, Tokyo (JP)

(72) Inventor: Shunsuke SATO, Kanagawa (JP)

(21) Appl. No.: 18/470,459

(22) Filed: Sep. 20, 2023

(30) Foreign Application Priority Data
Oct. 3, 2022 (JP) 2022-159714
Jul. 6, 2023 (JP) 2023-111583

(51) Int. Cl. G06V 40/16; G06T 7/73; G06V 10/26

(52) U.S. Cl. CPC G06V 40/172; G06T 7/73; G06V 10/26; G06V 40/168; G06T 2207/30201

(57) ABSTRACT

There is provided with an image processing apparatus. A determination unit determines, based on at least one of first face information and first posture information of a first person detected from an image, and second posture information of a second person different from the first person, whether a face of the first person is occluded by part of the first person or part of the second person. An authentication unit performs face authentication of the first person, in a case where the determination unit determines that the face of the first person is not occluded by part of the first person or part of the second person.

### BACKGROUND OF THE INVENTION

### Field of the Invention

The present invention relates to an image processing apparatus, an authentication system, a method, and a non-transitory computer-readable storage medium.

### Description of the Related Art

An image processing apparatus performs so-called face authentication for determining whether a face for comparison is the same a registered face, by comparing an image of the face for comparison with an image of the registered face. In the case where face authentication is performed using a moving image, the state of the face included in the moving image may vary. Thus, a method that involves selecting a still image applicable to face authentication from the moving image and utilizing the selected image for face authentication has been proposed. For example, a method that involves evaluating the image quality of facial images and constructing a three-dimensional facial shape model for face authentication using facial images having good image quality is described (Japanese Patent No. 4939968). Also, a method that involves detecting feature points of a face from multiple facial images, calculating the reliability of the face from the feature points of the face, and performing face authentication with a highly reliable facial image is described (Japanese Patent No. 6835223).

### SUMMARY OF THE INVENTION

According to the present invention, a technique for performing face authentication efficiently with consideration of an occlusion state of a person's face can be provided.

The present invention in its aspect provides an image processing apparatus comprising at least one processor, and at least one memory coupled to the at least one processor, the memory storing instructions that, when executed by the processor, cause the processor to act as a determination unit configured to determine, based on at least one of first face information and first posture information of a first person detected from an image, and second posture information of a second person different from the first person, whether a face of the first person is occluded by part of the first person or part of the second person, and an authentication unit configured to perform face authentication of the first person, in a case where the determination unit determines that the face of the first person is not occluded by part of the first person or part of the second person.

The present invention in its aspect provides a method comprising determining, based on at least one of first face information and first posture information of a first person detected from an image, and second posture information of a second person different from the first person, whether a face of the first person is occluded by part of the first person or part of the second person, and performing face authentication of the first person, in a case where the determining determines that the face of the first person is not occluded by part of the first person or part of the second person.

The present invention in its aspect provides a non-transitory computer-readable storage medium storing instructions that, when executed by a computer, cause the computer to perform a method comprising determining, based on at least one of first face information and first posture information of a first person detected from an image, and second posture information of a second person different from the first person, whether a face of the first person is occluded by part of the first person or part of the second person, and performing face authentication of the first person, in a case where the determining determines that the face of the first person is not occluded by part of the first person or part of the second person.

Further features of the present invention will become apparent from the following description of exemplary embodiments (with reference to the attached drawings).

### BRIEF DESCRIPTION OF THE DRAWINGS

FIG. 1 is a diagram showing an example of a hardware configuration of an image processing apparatus according to a first embodiment.

FIG. 2 is a diagram showing an example of a functional configuration of the image processing apparatus according to the first embodiment.

FIG. 3 is a flowchart illustrating authentication processing performed by the image processing apparatus according to the first embodiment.

FIG. 4A is a diagram showing the case where a person's face is occluded by the person's hand according to the first embodiment.

FIG. 4B is a diagram showing the case where a person's face is occluded by the person's hand according to the first embodiment.

FIG. 5A is a diagram showing the case where a person's face is occluded by the person's arm according to the first embodiment.

FIG. 5B is a diagram showing the case where a person's face is occluded by the person's arm according to the first embodiment.

FIG. 5C is a diagram showing the case where a person's face is occluded by the person's arm according to the first embodiment.

FIG. 5D is a diagram illustrating the case where a person's face is occluded by the person's arm according to the first embodiment.

FIG. 6 is a flowchart illustrating processing for selecting a model for extracting facial features according to the first embodiment.

FIG. 7 is a diagram illustrating effects of performing the authentication processing according to the first embodiment.

FIG. 8 is a diagram illustrating an example of associating posture information and face information according to the first embodiment.

FIG. 9 is a flowchart illustrating authentication processing performed by an image processing apparatus according to a second embodiment.

FIG. 10A is a diagram illustrating an example in which a person's face is occluded by another person's posture according to the second embodiment.

FIG. 10B is a diagram illustrating an example in which a person's face is occluded by another person's posture according to the second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

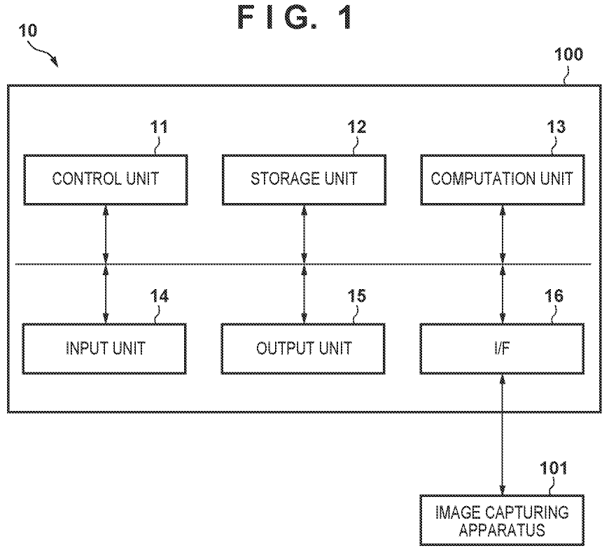

FIG. 1 is a diagram illustrating an example of a hardware configuration of an image processing apparatus according to the first embodiment.

An authentication system 10 includes an image processing apparatus 100 and an image capturing apparatus 101. The image processing apparatus 100 and the image capturing apparatus 101 are connected via an I/F 16. Note that the present embodiment can include a mode in which the image processing apparatus 100 and the image capturing apparatus 101 are integrated.

The image processing apparatus 100 includes a control unit 11, a storage unit 12, a computation unit 13, an input unit 14, an output unit 15, and the I/F 16.

The control unit 11 includes a micro-processing unit (MPU), and performs overall control of the constituent elements of the image processing apparatus 100.

The storage unit 12 includes an MPU and recording media such as a hard disk, and holds programs and data necessary for operations of the control unit 11.

The computation unit 13 includes an MPU and executes necessary computational processing, based on instructions from the control unit 11.

The input unit 14 is a human interface device or the like, and accepts user operations on the image processing apparatus 100.

The output unit 15 is an LCD display, an organic EL display or the like, and presents processing results of the image processing apparatus 100 and the like to the user.

The I/F 16 is a wired interface such as a universal serial bus, a local area network or an optical cable or a wireless interface such as Wi-Fi or Bluetooth. The I/F 16 is connected to the image capturing apparatus 101, and images captured by the image capturing apparatus 101 are transmitted to the image processing apparatus 100. Also, the image processing apparatus 100 transmits the results of processing various data externally via the I/F 16, and receives programs, data and the like necessary for operations of the image processing apparatus 100. Also, the I/F 16 is connected to an electronic lock of an entrance gate or gate door, or the like. The image processing apparatus 100 is able to transmit signals for opening/closing and locking/unlocking a gate and the like via the I/F 16 based on the processing results.

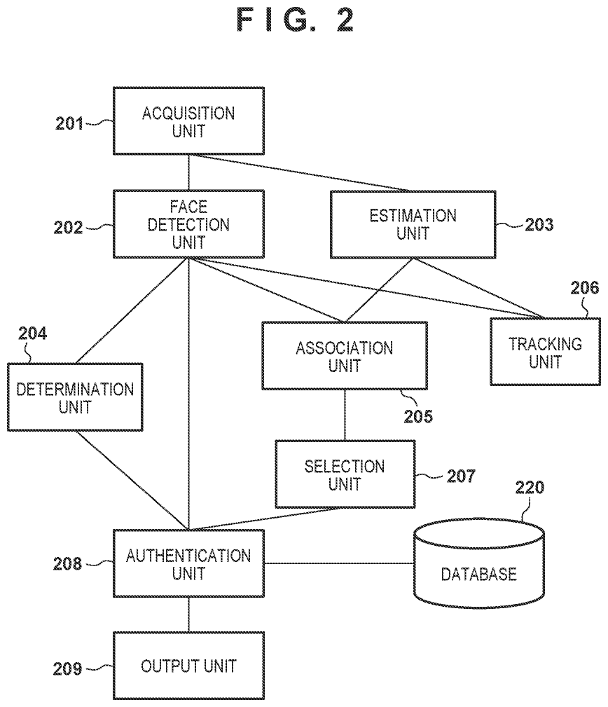

FIG. 2 is a diagram showing an example of a functional configuration of the image processing apparatus according to the first embodiment.

The image processing apparatus 100 includes an acquisition unit 201, a face detection unit 202, an estimation unit 203, a determination unit 204, a association unit 205, a tracking unit 206, a selection unit 207, an authentication unit 208, an output unit 209, and a database 220.

The acquisition unit 201 acquires images including human faces from the image capturing apparatus 101 via the I/F 16. Note that the acquisition unit 201 may acquire images from a communication line connected to the storage unit 12 and the I/F 16.

The face detection unit 202 detects a human face from an image acquired by the acquisition unit 201 and calculates face information, using a method shown in Non-Patent Document 1 (Ren, Shaoqing, et al. “Faster r-cnn: Towards real-time object detection with region proposal networks.” Advances in neural information processing systems. 2015), for example. Here, the face information includes a rectangle representing the position of the face in the image and a reliability score of the detected face. When a plurality of faces are detected from an image, the face detection unit 202 calculates face information that depends on the number of detected faces.

The estimation unit 203 estimates the posture of a human body from an image acquired by the acquisition unit 201, using a method shown in Non-Patent Document 2 (Cao, Zhe, et al. “Realtime Multi-Person 2D Pose Estimation using Part Affinity Fields.” CVPR 2017: 1302-1310), for example. The estimation unit 203 calculates posture information of the human body from the image. Here, the posture information includes the positions of the parietal, neck, right shoulder, right elbow, right hand, left shoulder, left elbow, left hand, chest, lower back, right hip, right knee, right ankle, left hip, left knee and left ankle (hereinafter collectively referred to as “joint points”) and a reliability score of each joint point. When a plurality of human bodies are included in an image, the estimation unit 203 calculates posture information that depends on the number of human bodies.

The determination unit 204 determines, for each face detected by the face detection unit 202, the state of the face. The determination unit 204 determines, as the state of the face, whether a face mask is being worn, whether sunglasses are being worn, whether lipstick is being worn, whether face paint is being worn, and the like. Note that the determination unit 204 may determine facial expression, hairstyle and the like, apart from things that are worn, makeup and the like.

The association unit 205 associates face information detected by the face detection unit 202 with posture information estimated by the estimation unit 203. The correspondence between face information and posture information is represented with one-to-one pairs, and signifies that the information relates to the same person. For example, the association unit 205 obtains a pair of face information and posture information, by means such as solving a minimum cost problem in which the distance between a center point of the rectangle representing the position of the face and a midpoint of the joint points of the parietal and neck as the cost, using a known method such as the Hungarian method. Note that the number of pieces of face information do not have to match the number of pieces of posture information, and all the face information and posture information need not be associated. For example, in the case where a person facing backwards appears in an image, posture information that cannot be associated with face information is obtained. Alternatively, in the case where only a person's face appears in an image with the rest of the body apart from the face being hidden, face information that cannot be associated with posture information is obtained.

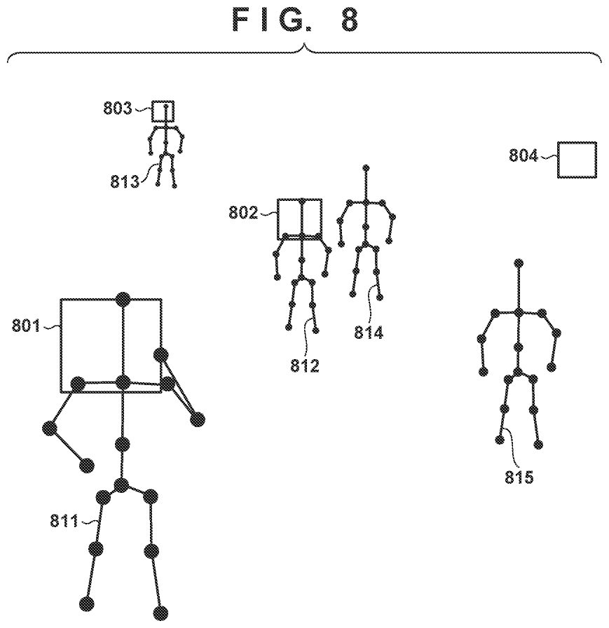

FIG. 8 is a diagram illustrating an example of associating posture information with face information according to the first embodiment. Note that FIG. 8 shows the result of posture information being associated with face information by the association unit 205.

FIG. 8 shows four pieces of face information 801 to 804 and five pieces of posture information 811 to 815. In FIG. 8, the pair of face information 801 and posture information 811 represents a first person, the pair of face information 802 and posture information 812 represents a second person, and the pair of face information 803 and posture information 813 represents a third person. On the other hand, the face information 804, the posture information 814 and the posture information 815 do not have corresponding (paired) face information or posture information. For example, for the face information 801, the posture information 812 to 815 represents the posture information of another person. Also, for the face information 804, the posture information 811 to 815 represents the posture information of another person.

The tracking unit 206 tracks a person based on the face information detected from an image by the face detection unit 202 and the posture information estimated by the estimation unit 203. The tracking unit 206 determines whether the person being tracked is the same as a target person, based on any of face information and posture information of an image captured immediately prior to tracking, using a method shown in Non-Patent Document 4 (Grabner, Helmut, et al. “Real-time tracking via on-line boosting.” Bmvc. Vol. 1. No. 5. 2006), for example.

The selection unit 207 selects an image to be used in face authentication from among the images acquired by the acquisition unit 201, using the pairs of face information and posture information associated by the association unit 205. A detailed method will be described later.

The authentication unit 208 performs face authentication by determining whether the face information detected by the face detection unit 202 is the same as any of the persons registered in the database 220. The database 220 is provided in the storage unit 12, and face information (i.e., feature values) of a plurality of persons is stored in advance. The authentication unit 208 uses a model to calculate a feature value from an image including a face detected by the face detection unit 202, and calculates the similarity between the calculated feature value and feature values in the database 220. If the similarity is greater than a threshold, the authentication unit 208 determines that the detected person is the same as a person registered in the database. The authentication unit 208 calculates feature values and compares feature values, using a method shown in Non-Patent Document 3 (DENG, Jiankang, et al. Arcface: Additive angular margin lossfor deep face recognition. In: Proceedings of the IEEE Conference on Computer Vision and Pattern Recognition. 2019. p. 4690-4699), for example.

The output unit 209 displays an authentication result of the authentication unit 208 on the output unit 15.

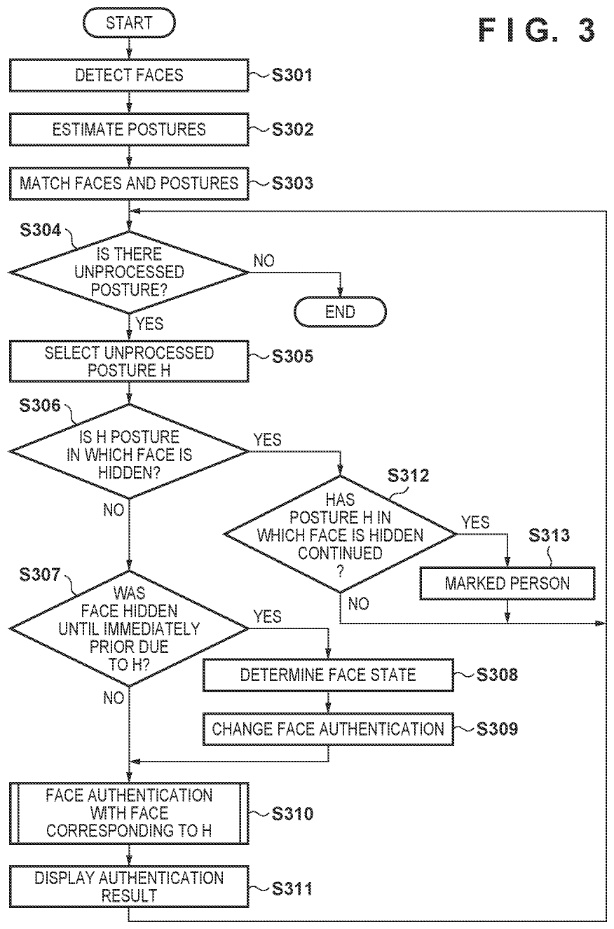

FIG. 3 is a flowchart illustrating authentication processing that is performed by the image processing apparatus according to the first embodiment.

In step S301, the face detection unit 202 detects faces of persons from an image and calculates face information F₁, . . . , F_{N}.

In step S302, the estimation unit 203 detects human bodies from the image, estimates the postures of the detected human bodies, and calculates posture information H₁, . . . , H_{M}.

In step S303, the association unit 205 calculates face and posture pairs P₁, . . . , P_{L} (L≤min (M, N)), by associating the face information and the posture information obtained in steps S301 and S302.

In step S304, the selection unit 207 determines whether there is unprocessed posture information H. Unprocessed posture information H refers to posture information that has not been used in processing from step S306 onward described later. If the selection unit 207 determines that there is unprocessed posture information H (Yes in step S304), the processing proceeds to step S305. If the selection unit 207 determines that there is no unprocessed posture information H (No in step S304), the processing ends.

In step S305, the selection unit 207 selects one piece of unprocessed posture information H from the posture information H calculated in step S302. If the posture information H is included in a pair P associated in step S303, the selection unit 207 determines face information F corresponding to the posture information H. Note that face information F corresponding to the posture information H may not exist.

In step S306, the selection unit 207 determines whether the face of the person corresponding to the posture information H is occluded by part (e.g., hand, arm) of the person. Specifically, the selection unit 207 determines whether the posture of the person corresponding to the posture information H is a posture that occludes the person's face, based on the face information F and the posture information H. If it is determined that the posture of the person corresponding to the posture information H is a posture that occludes the person's face (Yes in step S306), the selection unit 207 stores the determination result of the posture information H in the storage unit 12, and the processing proceeds to step S312. On the other hand, if the selection unit 207 determines that the posture of the person corresponding to the posture information H is not a posture that occludes the person's face (No in step S306), the determination result of the posture information H is stored in the storage unit 12, and the processing proceeds to step S307.

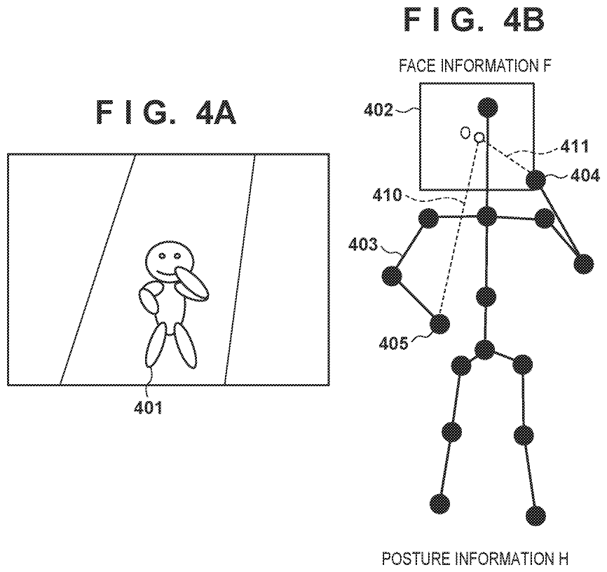

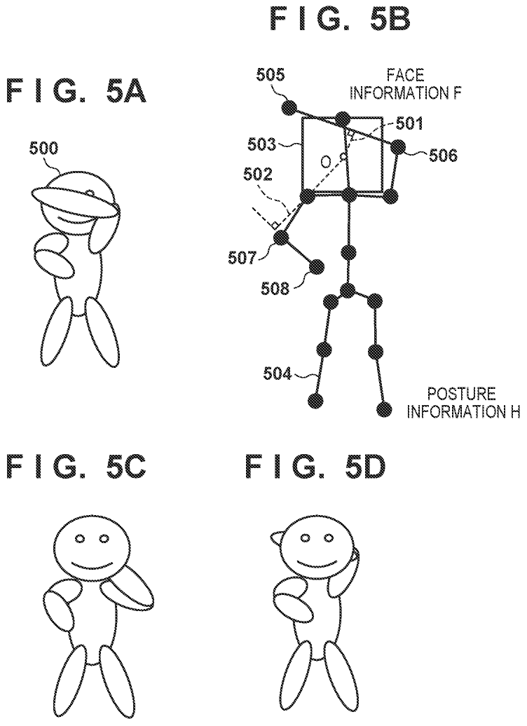

Here, the method by which the selection unit 207 determines whether a posture that is based on the posture information H is a posture that occludes the face of the person will be described, using FIGS. 4A and 4B and 5A to 5D.

FIGS. 4A and 4B are diagrams showing the case where a person's face is occluded by the person's hand according to the first embodiment. Note that “right” and “left” in FIGS. 4A and 4B are represented from the perspective of a person 401. In other words, “right” in FIGS. 4A and 4B corresponds to “left” for the person 401, and “left” in FIGS. 4A and 4B corresponds to “right” for the person 401.

FIG. 4A is a diagram showing a posture in which the person 401 in the image places the left hand in front of his or her face. For example, the person 401 adopts the posture shown in FIG. 4A in order to scratch an itchy part of his or her face. Alternatively, the person 401 adopts the posture shown in FIG. 4A in order to remove a face mask. The face detection unit 202 detects the face of the person 401 from the image and calculates face information F. The estimation unit 203 estimates the posture of the person 401 from the image and calculates posture information H.

FIG. 4B is a diagram showing the face information F and the posture information H of the person 401. A region 402 is the face information F of the person 401 and is represented by a rectangle representing the position of the face of the person 401. A posture 403 is the posture information H of the person 401 and is represented by a combination of the joint points of the person 401.

First, the selection unit 207 calculates a center point O of the region 402. The selection unit 207 then calculates a distance 411 (illustrated by dashed line) between the center point O and a left hand joint point 404 and a distance 410 (illustrated by dashed line) between the center point O and a right hand joint point 405. If the distance 410 or the distance 411 is smaller than a threshold T1, the selection unit 207 determines that the posture of the person 401 (right hand or left hand) is a posture that occludes his or her face. On the other hand, if the distance 410 and the distance 411 are not smaller than the threshold T1, the selection unit 207 determines that the posture of the person 401 is not a posture that occludes his or her face. Here, the threshold T1 is, for example, 0.9 times the length of the long side of the region 402, but is not limited thereto, and may be any value.

FIGS. 5A to 5D are diagrams showing the case where a person's face is occluded by the person's arm according to the first embodiment. Note that “right” and “left” in FIGS. 5A to 5D are represented from the perspective of a person 500. That is, “right” in FIGS. 5A to 5D corresponds to “left” for the person 500, and “left” in FIGS. 5A to 5D corresponds to “right” for the person 500.

FIG. 5A is a diagram showing a posture in which the person 500 in the image places his or her left arm in front of the face. For example, the person 500 adopts a posture shown in FIG. 5A such that dust or the like does not get into the eyes due to a strong wind. Alternatively, the person 500 adopts the posture shown in FIG. 5A in order to remove something stuck to the face. The face detection unit 202 detects the face of the person 500 from the image and calculates face information F. The estimation unit 203 estimates the posture of the person 500 from the image and calculates posture information H.

FIG. 5B is a diagram showing the face information F and the posture information H of the person 500. A region 503 is the face information F of the person 500 and is represented by a rectangle representing the position of the face of the person 500. A posture 504 is the posture information H of the person 500 and is represented by a combination of the joint points of the person 500. First, the selection unit 207 calculates a center point O of the region 503. The selection unit 207 then obtains a perpendicular line 501 from the center point O to a line segment between a left hand joint point 505 and a left elbow joint point 506, and a perpendicular line 502 from the center point O to a line segment between a right hand joint point 508 and a right elbow joint point 507. The selection unit 207 determines whether the perpendicular line 501 is on the line segment between the left hand joint point 505 and the left elbow joint point 506. Also, the selection unit 207 determines whether the perpendicular line 502 is on the line segment between the right hand joint point 508 and the right elbow joint point 507.

Next, the selection unit 207 determines that the perpendicular line 501 is on the line segment between the left hand joint point 505 and the left elbow joint point 506. On the other hand, the selection unit 207 determines that the perpendicular line 502 is not on the line segment between the right hand joint point 508 and the right elbow joint point 507. Incidentally, the perpendicular line 502 is on an extension line (illustrated by dashed line) of the line segment between the right hand joint point 508 and the right elbow joint point 507.

Furthermore, the selection unit 207 calculates the length of the perpendicular line 501, and determines that the face of the person 500 is occluded by the left arm of the person 500, based on whether the length of the perpendicular line 501 is smaller than a threshold T2. If the length of the perpendicular line 501 is smaller than the threshold T2, the selection unit 207 determines that the face of the person 500 is occluded by the left arm of the person 500. On the other hand, if the length of the perpendicular line 501 is not smaller than the threshold T2, the selection unit 207 determines that the face of the person 500 is not occluded by the left arm of the person 500. Here, the threshold T2 is, for example, 0.6 times the long side of the region 503, but is not limited thereto, and may be any value.

Here, in the case where the estimation unit 203 has the capacity to estimate the positions of some of the joint points related to occluding of a person's face, joint points of a person such as shown in FIGS. 5C and 5D can be estimated.

FIG. 5C is a diagram showing a posture in which a person places his or her left hand on the back of the head. FIG. 5D is a diagram showing a posture in which a person places his or her left arm on the back of the head.

In the case where occlusion determination of the face of the person in FIGS. 5C and 5D is performed with the determination method illustrated in FIGS. 4B and 5B, the selection unit 207 falsely determines that the person's face is occluded by the person's left hand or left arm. As illustrated in FIGS. 5C and 5D, the person's face is not occluded by the left hand or left arm. In view of this, if the reliability score of the joint point of the person's posture information H is less than a predetermined threshold, the selection unit 207 determines that the person's face is not occluded by part of the person's body. For example, if the distance between the left hand joint point and the center point of the face is smaller than a threshold and the reliability score of the left hand joint point is less than a predetermined threshold, the selection unit 207 determines that the person's face is not occluded by the person's left hand. In this way, the selection unit 207 is able to prevent false determination related to occluding of a person's face, by performing occluding determination of the person's face with consideration for not only the distance between the center of the person's face and the joint point but also with consideration for the reliability of the joint point.

Also, the selection unit 207 is able to perform occluding determination of a person's face, using a comparison of the length of a perpendicular line from the center point of the person's face to a line segment (i.e., left arm) between the left hand joint point and the left elbow joint point with a threshold, and an average score derived from the reliability score of the hand joint point and the reliability score of the elbow joint point. In the case where the estimation unit 203 is able to calculate the degree of occlusion for each joint point, three-dimensional depth information and the like, the anteroposterior relationship between the joint points and the face may be determined using that information.

Note that the selection unit 207 is able to perform occlusion determination of a person's face using not only the hand joint points, the elbow joint points, and the forearms but also the upper arms, the ankle joint points, the torso and the like. Here, the description returns to FIG. 3.

In step S312, the tracking unit 206 determines whether the person corresponding to the posture information H is adopting a posture in which the face is continuously hidden, while tracking the person. That is, the tracking unit 206 determines that the person is adopting a posture in which the face is continuously hidden, in the case where the face of the person corresponding to the posture information H is occluded in a large proportion of images of continuous times immediately prior to the determination. Specifically, the tracking unit 206 determines that the person is adopting a posture in which the face is continuously hidden, in the case where the person's face is occluded for more than 90% of the 10 seconds immediately prior to the determination.

If the tracking unit 206 determines that the person is adopting a posture in which the person's face is continuously hidden (Yes in step S312), the processing proceeds to step S313. On the other hand, if the tracking unit 206 determines that the person is not adopting a posture in which the person's face is continuously hidden (No in step S312), the processing returns to step S304.

In step S313, the tracking unit 206 labels the person corresponding to the posture information H as “marked person”. Also, the output unit 209 notifies an alarm sound or message to a user terminal (e.g., a smartphone, tablet, etc.) when the person is labelled as “marked person”, and changes the display color or icon of the person labelled as “marked person”. After the processing of step S313 has ended, the processing returns to step S304. Note that a person who has been labeled as “marked person” could possibly be attempting unauthorized face authentication, by intentionally hiding his or her face or trying to impersonate another person by manipulating his or her face. Thus, the output unit 209 performs display on the user terminal urging vigilance toward the marked person. The user is thereby able to recognize the person who may be attempting unauthorized face authentication, by checking his or her terminal or the like.

In step S307, the tracking unit 206 determines whether the face of the person corresponding to the posture information H is occluded due to his or her posture in an image captured at a time immediately prior, while tracking the person. If the tracking unit 206 determines that the person's face is occluded due to his or her posture in an image captured at a time immediately prior (Yes in step S307), the processing proceeds to step S308. On the other hand, if the tracking unit 206 determines that the person's face is not occluded due to his or her posture in an image captured at a time immediately prior (No in step S307), the processing proceeds to step S310.

In step S308, the determination unit 204 determines the state of the person's face based on face information F corresponding to the posture information H. The determination unit 204 determines whether the person is wearing any of a face mask, sunglasses, lipstick and makeup in the facial image of the face information F.

In step S309, the authentication unit 208 changes the model for extracting features from the image, based on the state of the face appearing in the image. The authentication unit 208 holds a general model, a female model, a sunglasses model, and a face mask model, for example, as examples of models. A model is, for example, a neural network that learns using training data and ground truth data. The authentication unit 208 extracts facial feature values from the image using any one of the above models during face authentication. The general model is a model learned with facial images in which the occluded state of the face is unspecified. The female model, sunglasses model and face mask model are respectively models learned by increasing the proportion of images of woman's faces, faces with sunglasses on, and faces with a face mask on.

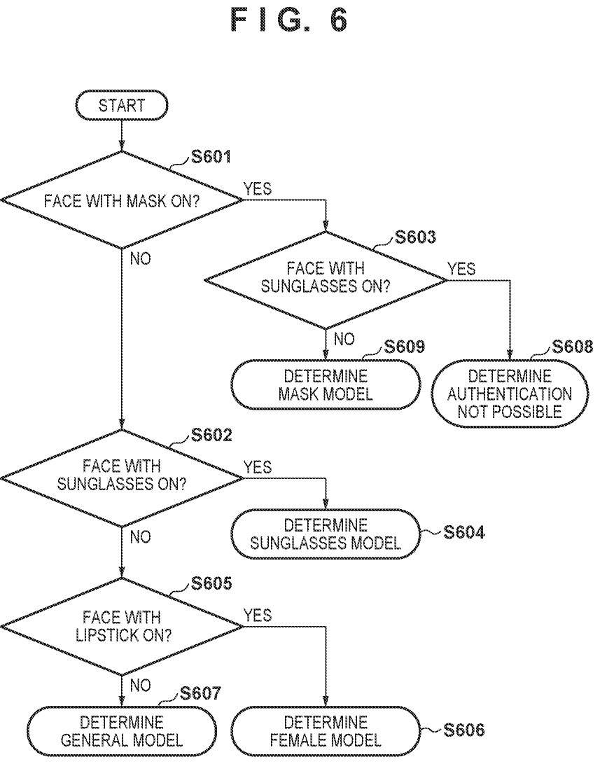

Here, FIG. 6 is a flowchart illustrating processing for selecting a model for extracting facial features according to the first embodiment.

In step S601, the authentication unit 208 determines whether the face is with a face mask on, based on the number of facial organs in the face information F detected by the face detection unit 202. If the number of facial organs (e.g., left eye, right eye, and nose) is three, the authentication unit 208 determines that there is a face mask on the face (Yes in step S601), and the processing proceeds to step S603. If the number of facial organs (e.g., left eye, right eye, nose, left edge of mouth, and right edge of mouth) is five, the authentication unit 208 determines that there is a face mask on the face (No in step S601), and the processing proceeds to step S602. Note that the method for determining whether there is a face mask on a face is not limited to the method based on the number of facial organs described above. For example, the authentication unit 208 may determine whether there is a face mask on a face, based on whether a face mask region is detected by the face detection unit 202.

In step S602, the authentication unit 208 determines whether the face is wearing sunglasses, based on the number of facial organs in the face information F detected by the face detection unit 202. If the number of facial organs (e.g., nose, left edge of mouth, and right edge of mouth) is three, the authentication unit 208 determines that sunglasses are on the face (Yes in step S602), and the processing proceeds to step S604. On the other hand, if the number of facial organs (e.g., left eye, right eye, nose, left edge of mouth, and right edge of mouth) is five, the authentication unit 208 determines that sunglasses are not on the face (No in step S602), and the processing proceeds to step S605. Note that the authentication unit 208 may determine whether there are sunglasses on the face, based on whether a region of sunglasses is detected by the face detection unit 202.

In step S603, the authentication unit 208 determines whether there are sunglasses on the face based on the number of facial organs in the face information F detected by the face detection unit 202. If the number of facial organs is zero, the authentication unit 208 determines that there are sunglasses on the face (Yes in step S603), and the processing proceeds to step S608. On the other hand, if the number of facial organs (e.g., left eye, right eye, and nose) is three, the authentication unit 208 determines that there are sunglasses on the face (No in step S603), and the processing proceeds to step S609. Note that the authentication unit 208 may determine whether there are sunglasses on face, based on whether a region of sunglasses is detected by the face detection unit 202.

In step S604, the authentication unit 208 determines the sunglasses model as the model for extracting features from the image.

In step S605, the authentication unit 208 determines whether the target person is female or male. If female (Yes in step S605), the processing proceeds to step S606. On the other hand, if the target person is male (No in step S605), the processing proceeds to step S607. Note that gender need only be determining using the skeletal structure of the face or features of the whole body showing clothing, or using a neural network that determines the presence or absence of makeup.

In step S606, the authentication unit 208 determines the female model as the model for extracting features from the image.

In step S607, the authentication unit 208 determines the general model as the model for extracting features from the image.

In step S608, the authentication unit 208 does not determine a model for extracting features from the image, and determines not to perform face authentication (i.e., authentication not possible). This is because it is difficult for the authentication unit 208 to detect the majority of facial organ points from a face with a face mask and sunglasses on.

In step S609, the authentication unit 208 determines the face mask model as the model for extracting features from the image.

Here, if the authentication unit 208 determines the female model in step S606, the similarity between the facial features of the image and the facial features in the database may be reduced, even when the face in the image is the same as a face in the database described later. Thus, the authentication unit 208 sets the threshold for comparing with the similarity to a value multiplied by 0.9, for example. Note that the authentication unit 208 may set different thresholds according to the model ultimately selected. Here, the description returns to FIG. 3.

In step S310, the authentication unit 208 determines whether it is the same person, based on a comparison of the similarity between the features extracted from the face information F corresponding to the posture information H using the determined model and facial features registered in the database 220 with the threshold. The authentication unit 208 uses the model and threshold determined in step S309. On the other hand, if the processing of step S309 is not executed, the authentication unit 208 uses the model and threshold used for an image of an immediately previous time. Note that if it is determined in step S309 that “authentication not possible”, the authentication unit 208 does not compare the features extracted from the face information F corresponding to the posture information H with facial features registered in the database 220.

Note that, if the person corresponding to the posture information H is labelled as “marked person” in step S313, the authentication unit 208 performs the following processing. First, the authentication unit 208 determines, for the face information F, whether the face is a real human face, that is, whether the face is not an impersonation with a printout of a face or a disguise mask. If it is determined that the face that is based on the face information F is not a real human face, the authentication unit 208 does not perform a comparison with the database 220, similarly to the case where “authentication not possible” is determined. Also, if it is determined that the face that is based on the face information F is a real human face, the authentication unit 208 performs face authentication. Note that, in order to lower the risk of false authentication, the authentication unit 208 uses a value multiplied by 1.1, for example, as a new threshold instead of the threshold determined in step S309. The new threshold can be changed as appropriate from the viewpoint of convenience and tolerance of the false authentication risk, for example.

In step S311, the output unit 209 outputs the result of authenticating the features extracted from the face information F corresponding to the posture information H against facial features registered in the database 220. For example, the output unit 209 displays the face information F, the posture information H and the authentication result on a screen. The output unit 209 displays the respective outputs, that is, the case where the features of the face information F match facial features in the database, the case where the features of the face information F do not match facial features in the database, and the case where “authentication not possible”, in different colors. This makes it easier for the user to confirm what kind of authentication result was obtained, when he or she looks at the screen.

The output unit 209 stores information indicating that the posture information H has been processed in the storage unit 12, and the processing returns to step S304.

The image processing apparatus 100 repeats the above processing and performs processing on all the posture information H detected from the image. When there is no more unprocessed posture information H, the processing is ended. This authentication processing is performed whenever the acquisition unit 201 acquires a video frame image. Face authentication is thereby performed on the person in the video. Also, if it is detected, as a result of the processing of the step S306, that a person's face is hidden by his or her hand or arm, face authentication is not executed and thus the efficiency of face authentication is improved.

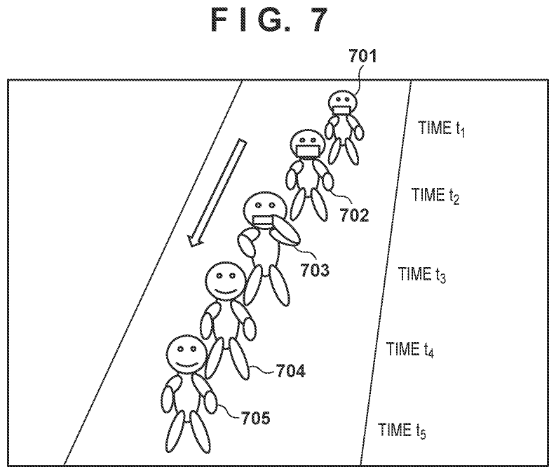

FIG. 7 is a diagram illustrating the effects in the case where the authentication processing according to the first embodiment is performed.

FIG. 7 shows one person walking toward the near side from the far side in the video. The arrows in the diagram represent the direction of travel of the person. The image of FIG. 7 is obtained by superimposing images of the person taken at respective times. An image of a person 701 is taken at time t1. An image of a person 702 is taken at time t2. An image of a person 703 is taken at time t3. An image of a person 704 is taken at time t4. An image of a person 705 is taken at time t5. Incidentally, the persons 701 to 705 are the same person, but the states of the face of the persons 701 to 705 are not all the same.

The person 701 at time t1 is wearing a face mask. At time t3, the person 703 performs the action of removing the face mask with the left hand. From time t4 onward, the person is not wearing a face mask. Note that it is assumed that, at time t1, time t2, time t4 and time t5, the person does not move a hand or arm close to the face, and is not wearing sunglasses, lipstick or paint. Paint includes makeup and face paint, for example.

First, when the person 701 is detected at time t1, the determination unit 204 determines the state of the face of the person 701, based on the face information F of the person 701 (processing of step S308). The authentication unit 208 determines the “face mask model” as the model for extracting features from the image, based on the determination result of the state of the face of the person 701 by the determination unit 204 (processing of step S309). The authentication unit 208 then compares the facial features of the person 701 extracted from the image using the face mask model with facial features registered in the database 220.

At time t2, since the person 701 was not occluding the face with a hand or arm at the immediately previous time t1, the processing of step S308 and step S309 is not performed. The authentication unit 208 then compares the facial features of the person 702 extracted from the image using the face mask model determined at time t1 with facial features registered in the database 220. The processing of steps S308 and S309 are omitted, since it is assumed that the person has not moved a hand close to the face between time t1 and time t2 and there is no change in the state of the person's face. The image processing apparatus 100 is thereby able to economize calculation resources related to the processing of step S308 and step S309.

At time t3, since the left hand of the person 703 is positioned at the face (i.e., selection unit 207 determines that the face of person 703 is occluded by the left hand), the authentication unit 208 does not compare the face information F of the person 703 with the database 220.

At the immediately previous time t3, the left hand of the person 703 was positioned at the face, but at the time t4, the left hand of the person 704 is not positioned at the face. In this case, the processing of steps S308 and S309 are executed. In other words, the determination unit 204 determines that there is no face mask on the face as the state of the face, based on the face information F of the person 704. The authentication unit 208 then determines the “general model” as the model for extracting facial features of the person 704 from the image, and compares the facial features of the person 704 extracted from the image using the general model with facial features in the database 220.

Since the person 703 had placed the left hand at the position of the face at time t3 (i.e., face of person 703 was occluded), it is highly likely that the state of the face has changed at time t4. Thus, the determination unit 204 again determines the state of the face of the person 704, and the authentication unit 208 determines the model based on the state of the face. At time t4, since the state of the face has changed from having a face mask on to not having a face mask on, the authentication unit 208 switches from the “face mask model” to the “general model”. Here, the person 703 has placed the left hand at the position of the face at time t3, but it is also possible that the action of the person 703 is not an action that changes the state of the face (i.e., action of removing face mask). However, even if the face mask remained on the face of the person 704 at time t4, the determination unit 204 determines that the state of the face (i.e., face with face mask on) is similar to time t3. Thus, the face mask model remains as the model that is used by the authentication unit 208, and the model is not changed.

At time t5, similarly to time t2, the face is not occluded by a hand or arm of the person 704 at the immediately previous time t4, and thus the authentication unit 208 compares the facial features of the person 704 extracted from the image using the general model determined at time t4 with facial features in the database 220.

In this way, the image processing apparatus 100 is able to predict the timing of a change in the state of the face using the person's posture information H and reduce the number of times the state of the face is determined, and thus has the effect of cutting back on calculation resources. Also, the image processing apparatus 100 is able to distinguish between the case where another person's hand happens to approach the face of the target person in a video and the case where the target person's hand approaches his or her face, by associating the face information F with the posture information H. In this way, the image processing apparatus 100 is able to more accurately determine whether an action can change the state of a person's face, by associating the face information F and the posture information H.

According to the present embodiment, since a facial image in which a person occludes the face with part of the person's body is not used as an image for face authentication, face authentication can be efficiently performed using a facial image in which a face that is not occluded appears.

### Second Embodiment

In a second embodiment, a method that does not use a person's facial image as a face authentication image, in the case where the person's face is occluded by part of another person's body, will be described. Note that, in the second embodiment, differences from the first embodiment will be described.

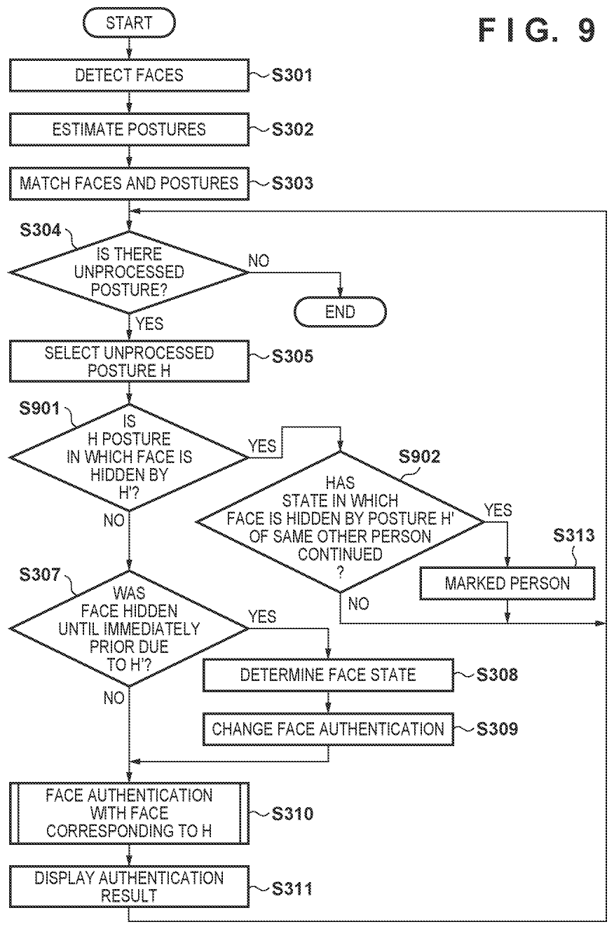

FIG. 9 is a flowchart illustrating authentication processing performed by an image processing apparatus according to the second embodiment. Note that, since the steps having the same number as the flowchart of FIG. 3 are common to the first embodiment, FIG. 9 illustrates the differences from FIG. 3.

Step S901 is executed instead of step S306 in FIG. 3. In step S901, the selection unit 207 determines whether a face of a person that is based on face information F corresponding to the posture information H selected in step S305 is occluded by part (e.g., hand, arm) of another person that is based on other posture information H′ excluding the posture information H. Specifically, the selection unit 207 selects the face information F and one piece of the other posture information H′, and determines whether the posture of another person that is based on the posture information H′ occludes the face of the person that is based on the face information F. This determination processing is repeatedly performed for all the other posture information H′ in the same image. If it is determined that the posture based on one or more pieces of other posture information H′ is a posture that occludes the face of the person that is based on the face information F, it is determined that the person's face is occluded by part of the body of another person.

If it is determined that the face of the person that is based on the face information F is occluded by a posture that is based on other posture information H′ (Yes in step S901), the selection unit 207 stores the determination result of the other posture information H′ in the storage unit 12, and the processing proceeds to step S902. On the other hand, if it is determined that the face of the person that is based on the face information F is not occluded by a posture that is based on other posture information H′ (No in step S901), the selection unit 207 stores the determination result of the other posture information H′ in the storage unit 12, and the processing proceeds to step S307.

The method by which the selection unit 207 determines whether the posture of another person that is based on other posture information H′ is a posture that occludes the face of a person that is based on the face information F is similar to the method used in step S306 of the first embodiment. In the case where a person's face is occluded by part of another person's body, the person's face could, however, be occluded by any part on the other person's body. Thus, not only the hand joint points, the elbow joint points and the forearms but also the upper arms, the ankle joint points, the torso and the head joint point, and line segments connecting these joint points are also used to determine whether the person's face is occluded by part of the body of another person.

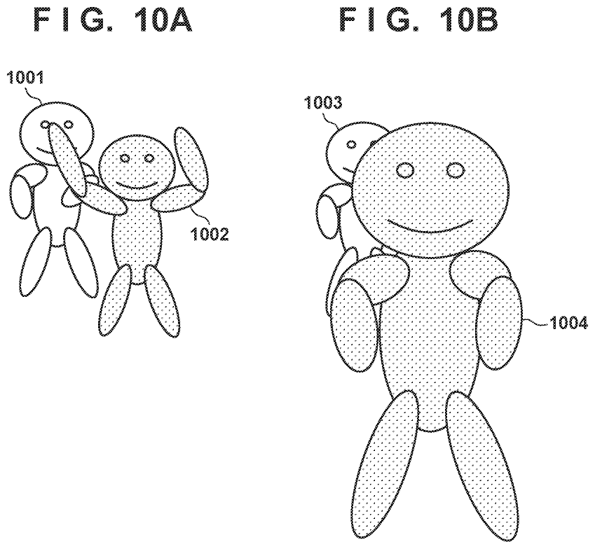

FIGS. 10A and 10B are diagrams illustrating examples in which a person's face is occluded by the posture of another person according to the second embodiment. FIG. 10A shows a state in which the face of a person 1001 is occluded by a raised arm of another person 1002. Also, FIG. 10B shows a state in which the face of a person 1003 is occluded by the head of another person 1004 who is standing in front. In FIG. 10B, the anteroposterior positional relationship between the person and the other person may be distinguished by apparent size. Here, the description returns to FIG. 9.

Step S902 is performed instead of step S312 in FIG. 3. In step S902, the tracking unit 206 determines whether the face of the person corresponding to the posture information H is continuously hidden by the posture that is based on the posture information H′ of the same other person, while tracking the person. That is, the tracking unit 206 determines that the person is adopting a posture in which the face is continuously hidden by part of the body of the same other person, in the case where the face of the person corresponding to the posture information H is occluded in a large proportion of images of continuous times immediately prior to the determination, and the face is occluded, to a large proportion, by a posture that is based on the posture information H′ of the same other person. Specifically, the tracking unit 206 determines that the person is adopting a posture that continuously hides the face, in the case where the person's face is occluded for more than 90% of the 10 seconds immediately prior to the determination and 80% of the other persons who are occluding the person's face are the same other person.

If the tracking unit 206 determines that the person's face is continuously hidden by part of the body of the same other person (Yes in step S902), the processing proceeds to step S313. If the tracking unit 206 determines that the person's face is not continuously hidden by part of the body of the same other person (No in step S902), the processing returns to step S304.

Here, if the person's face is continuously occluded by the same other person, it is possible that the person is colluding with the other person to intentionally hide his or her face or manipulate the face of the other person. Thus, in step S313, the tracking unit 206 sets the person as “marked person”. On the other hand, if the person's face continues to be occluded, but the person's face is occluded by different other persons, the possibility of unauthorized face authentication described above is assumed to be low. Thus, the tracking unit 206 does not set the person as “marked person”.

Note that, in order to determine the possibility of collusion for unauthorized face authentication, criteria such as whether the occluding of the person's face is by a hand or arm of another person and whether another person is in close proximity to the person may be added as determination criteria for when face authentication is performed.

According to the present embodiment, since a facial image in which the person's face is occluded by part of another person's body is not used as a face authentication image, face authentication can be performed efficiently. Note that the second embodiment may not only be executed in a stand alone manner, but may also be executed at the same time as the first embodiment. At this time, steps common to the first embodiment and the second embodiment can be executed by sharing the processing.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-159714, filed Oct. 3, 2022, and Japanese Patent Application No. 2023-111583, filed Jul. 6, 2023 which are hereby incorporated by reference herein in their entirety.

What is claimed is:

1. An image processing apparatus comprising:
at least one processor; and
at least one memory coupled to the at least one processor, the memory storing instructions that, when executed by the processor, cause the processor to act as:
a determination unit configured to determine, based on at least one of first face information and first posture information of a first person detected from an image, and second posture information of a second person different from the first person, whether a face of the first person is occluded by part of the first person or part of the second person; and
an authentication unit configured to perform face authentication of the first person, in a case where the determination unit determines that the face of the first person is not occluded by part of the first person or part of the second person.

2. The image processing apparatus according to claim 1, further comprising:
a face determination unit configured to determine a state of the face of the first person, in a case where the face of the first person is occluded by part of the first person or part of the second person in an image captured before the image from which the first person is detected,
wherein the authentication unit performs face authentication of the first person, using a model that is based on the state of the face of the first person.

3. The image processing apparatus according to claim 1,
wherein, in a case where the determination unit determines that the face of the first person is occluded by part of the first person or part of the second person, the authentication unit inhibits face authentication of the first person.

4. The image processing apparatus according to claim 2,
wherein the face determination unit determines the state of the face of the first person, in a case where the face of the first person is not occluded by part of the first person or part of the second person in an image captured before the image from which the first person is detected.

5. The image processing apparatus according to claim 2,
wherein the model is a model for extracting a feature of the face of the first person from the image from which the first person is detected.

6. The image processing apparatus according to claim 1, further comprising:
a corresponding unit configured to associate face information and posture information of a same person in the image.

7. The image processing apparatus according to claim 1,
wherein the determination unit determines whether the face of the first person is occluded by part of the first person or part of the second person, based on the first face information and a reliability of one of a joint point of the first person in the first posture information and a joint point of the second person in the second posture information.

8. The image processing apparatus according to claim 1,
wherein the determination unit determines whether the face of the first person is occluded by part of the first person or part of the second person, based on a distance between a position of the face of the first person and a position of one of a joint point of the first person in the first posture information and a joint point of the second person in the second posture information.

9. The image processing apparatus according to claim 1, further comprising:
a comparing unit configured to compare a feature of the face of the first person with a feature of a face of a registered first person.

10. The image processing apparatus according to claim 9,
wherein the comparing unit compares whether the face of the first person is the same as the face of the registered first person, based on a similarity between the feature of the face of the first person and the feature of the face of the registered first person.

11. The image processing apparatus according to claim 2,
wherein the state of the face of the first person is at least one of a state in which the face of the first person is wearing a face mask, a state in which the face of the first person is wearing sunglasses, and a state in which the face of the first person is wearing lipstick.

12. The image processing apparatus according to claim 9, further comprising:
a display unit configured to display a comparison result of the comparing unit with a method that depends on the comparison result.

13. The image processing apparatus according to claim 1,
wherein the determination unit sets the first person as a marked person, in a case where it is determined that a state in which the face of the first person is occluded by part of the first person or part of the second person is continuous.

14. The image processing apparatus according to claim 13, further comprising:
a notification unit configured to notify a user terminal that the first person is set as a marked person.

15. The image processing apparatus according to claim 13,
wherein the authentication unit changes a face authentication method of the first person set for the marked person.

16. An authentication system comprising:
an image capturing apparatus configured to capture an image of a subject; and
the image processing apparatus according to claim 1.

17. A method comprising:
determining, based on at least one of first face information and first posture information of a first person detected from an image, and second posture information of a second person different from the first person, whether a face of the first person is occluded by part of the first person or part of the second person; and
performing face authentication of the first person, in a case where the determining determines that the face of the first person is not occluded by part of the first person or part of the second person.

18. A non-transitory computer-readable storage medium storing instructions that, when executed by a computer, cause the computer to perform a method comprising:
determining, based on at least one of first face information and first posture information of a first person detected from an image, and second posture information of a second person different from the first person, whether a face of the first person is occluded by part of the first person or part of the second person; and
performing face authentication of the first person, in a case where the determining determines that the face of the first person is not occluded by part of the first person or part of the second person.
